(19) United States
(12) Patent Application Publication
(10) Pub. No.: US 2015/0204434 A1
(43) Pub. Date: Jul. 23, 2015

(54) HIGH SPEED GEARBOX VENT

(71) Applicant: Deere & Company, Moline, IL (US)

(72) Inventors: Scott R. Wiens, Cedar Falls, IA (US); Eric T. Lammers, Cedar Falls, IA (US)

(73) Assignee: Deere & Company, Moline, IL (US)

(21) Appl. No.: 14/161,383

(22) Filed: Jan. 22, 2014

(51) Int. Cl. F16H 57/027

(52) U.S. Cl. CPC F16H 57/027

(57) ABSTRACT

A high speed gearbox includes a housing which encloses a rotating gear and a volume which contains oil and air. The gear has an outer first surface exposed to the volume and has a second surface exposed to the environment. A vent arrangement includes first and second passages formed in the gear. The second passage extends axially part way into the gear and has an outer end exposed to the second surface. The first passage extends radially from the first surface to the second passage. A check valve is mounted in the second passage and permits one-way flow of air from the volume to the environment.

### FIELD

The present disclosure relates to a vent for a gearbox.

### BACKGROUND

Vehicle transmissions have shafts and gears which rotate in a housing which forms an oil sump so that the parts are adequately coated with lubricating oil while they rotate. The interior of the transmission must be vented or communicated with the atmosphere to prevent pressure from building up in the transmission as temperatures increase. But, the vent must not allow oil to be pushed out of the transmission along with the air. In a known large transmission or gearbox, radial and axial vent passages are drilled through a shaft which is positioned above the sump oil level. Oil is prevented from being expelled along with the air during non-rotation because the shaft is significantly above the sump oil level.

However, in a smaller gearbox with high rpm gears, all areas and parts of the gearbox will be exposed to splashing oil. Thus, there is not any place to locate a conventional vent arrangement which will not allow oil to be expelled. Such a smaller gearbox needs a different vent arrangement which will prevent oil from being expelled along with the air being vented.

### SUMMARY

According to an aspect of the present disclosure, a gearbox has a housing which encloses a rotating gear and a volume which contains oil and pressurized air. The gear has a first surface exposed to the volume and a second surface exposed to the environment. A vent arrangement includes first and second passages formed in the gear. The second passage extends part way into the gear and has an outer end exposed to the second surface. The first passage extends radially outwardly from the second passage to the first surface. The second passage extends axially along a central axis of the gear. A check valve is mounted in the second passage and permits one-way flow of air from the volume to the environment.

### BRIEF DESCRIPTION OF THE DRAWINGS

FIG. 1 is an exploded perspective view of a gearbox which embodies the present invention; and

FIG. 2 is a sectional view along lines 2-2 of FIG. 1.

### DETAILED DESCRIPTION OF THE DRAWINGS

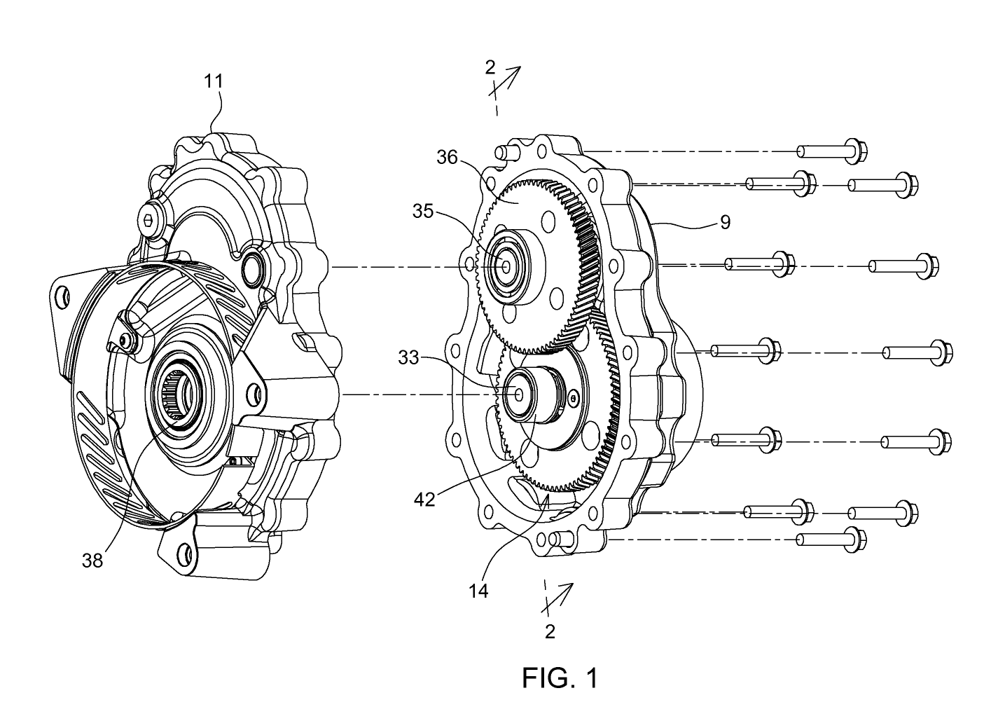

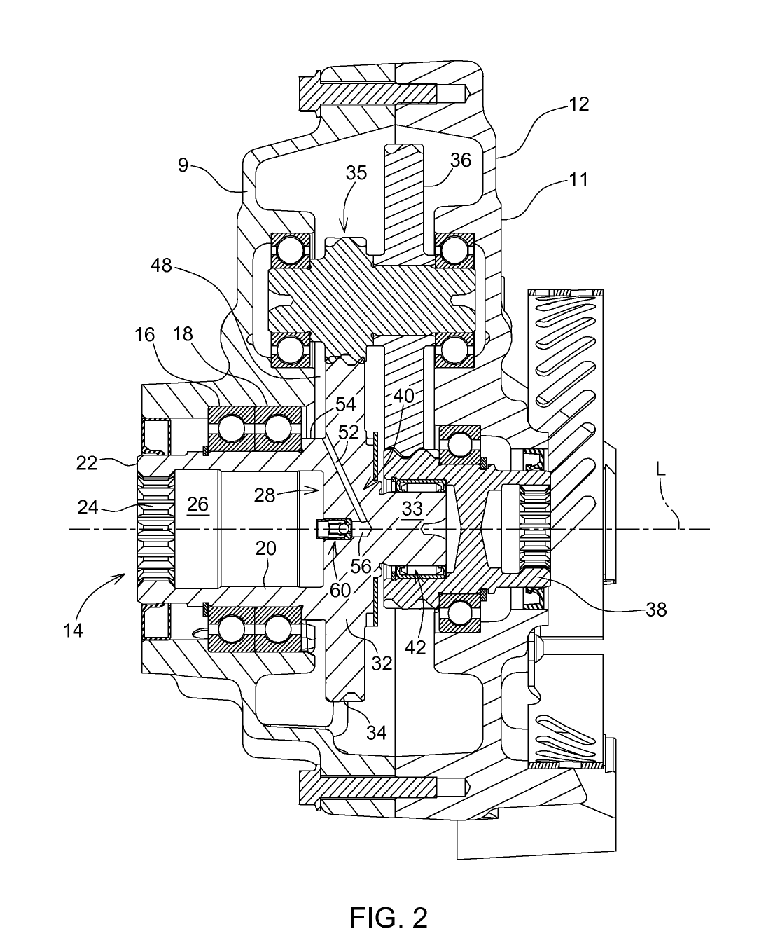

Referring to FIGS. 1 and 2, a rotary machine such as a gearbox 10, such as for a power take off (PTO), includes bolted together housing parts 9 and 11 which form an outer housing 12 which surrounds a rotating part or input gear 14. Referring now to FIG. 2, a pair of bearings 16, 18 support the gear 14 for rotation at high speeds, such as 1000 rpm. Gear 14 includes a hollow cylindrical portion 20 with an output end 22 which has internal gear teeth 24 adapted to receive and meshingly engage external teeth or splines (not shown) on a vehicle PTO shaft (not shown). Thus, the interior 26 of the cylindrical portion 20 is exposed to the exterior environment. The cylindrical portion 20 is supported by the bearings 16 and 18. The gear 14 also includes and input end 28 which forms a cylindrical flange 30 with a solid central hub 32. A central shaft 33 extends axially from the hub 32.

Gear teeth 34 are formed on an outer surface of the flange 30. The teeth 34 are adapted to engage a driving gear 35. Gear 35 is coupled to gear 36 which drives an output gear 38. Output gear 38 has a hollow inner end 40 which supported for rotation with respect to the shaft 33 by an annular needle bearing 42. The housing 12 is partially filled with lubricating oil which normally is filled to a level L. The gear 14 rotates though the oil and flings the oil though most of the interior of the housing 12.

Thus, the housing 12 encloses a volume 48 which contains air and oil. The gear 14 includes a vent arrangement 50. The vent arrangement 50 includes a first passage 52 and a second passage 56. First passage 52 extends radially inwardly and axially from an outer surface 54 of the cylindrical portion 20 of gear 14 to an end of the second passage 56. Second passage 56 extends axially part way into the hub 32 from surface 29, opens into the interior 26 of the gear 14 and is aligned with a rotation axis of the gear 14. Thus, passages 52 and 56 communicate the volume 48 with the interior 26 of gear 14, and thus, to the environment.

The vent arrangement 40 also includes a check valve 60 which is mounted in the axial second passage 56. The check valve 60 permits air to flow one-way from first passage 52, through second passage 56 and into the interior 26 of the gear 14, and thus to the environment. Thus, when the temperature rises in volume 48, the air expands and pressure is relieved to the environment though passage 52, passage 56 and check valve 60. However, when the gear 14 is rotating, centrifugal force prevents oil from flowing radially inwardly though passage 52. Thus, the vent arrangement formed by passages 52 and 56 prevent oil from being expelled to the environment while allowing venting of air. When the gearbox 10 cools down and air needs to flow back into the volume 48 from the environment, such air can flow through the seals (not shown) of the gearbox 10.

The result is a gearbox with a breather function or vent which prevents sump oil from leaking to the environment, despite being in a location which is partially submerged in the sump oil. The radial passage 52 will prevent oil from leaking during operation, when the gear 14 is rotating. The check valve 60 will prevent oil from leaking to the environment when the gear box 10 is not in use and the gear 14 is covered by sump oil.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

What is claimed is:

1. In a gearbox having a housing enclosing a rotating gear and enclosing a volume which can contain oil and pressurized air, the gear having a first surface exposed to the volume and having a second surface exposed to the environment, a vent arrangement comprising:
first and second passages formed in the gear, the second passage extending part way into the gear and having an outer end exposed to the second surface, the first passage extending from the first surface to the second passage.

2. The vent arrangement of claim 1, wherein:
the second passage extends axially.

3. The vent arrangement of claim 1, wherein:
the second passage extends axially along a central axis of the gear.

4. The vent arrangement of claim 1, wherein:
the first passage extends radially outwardly from the second passage to the first surface.

5. The vent arrangement of claim 1, further comprising:
a check valve which permits one-way flow of air from the volume to the environment.

6. The vent arrangement of claim 5, wherein:
the check valve is mounted in the second passage.

7. In a gearbox having a housing enclosing a rotating gear and enclosing a volume which can contain oil and pressurized air, the gear having a first surface exposed to the volume and having a second surface exposed to the environment, a vent arrangement comprising:
a first passage formed in the gear;
a second passage extending axially part way into the gear and having an outer end exposed to the second surface, the first passage extending radially from the first surface to the second passage; and
a check valve which permits one-way flow of air from the volume to the environment.

8. The vent arrangement of claim 7, wherein:
the check valve is mounted in the second passage.

9. In a gearbox having a housing enclosing a rotating gear and enclosing a volume which can contain oil and pressurized air, the gear having a first surface exposed to the volume and having a second surface exposed to the environment, a vent arrangement comprising:
a passage formed in the gear, the passage having a first end communicating with the volume and having a second communicating with the environment, the passage having a portion thereof which extends radially through a portion of the gear; and
a check valve which permits one-way flow of air through the passage from the volume to the environment.

10. The vent arrangement of claim 9, wherein:
the passage comprises a further portion which extends axially part way into the gear and which has an outer end exposed to the environment.

11. The vent arrangement of claim 10, wherein:
the further portion of the passage is aligned with a rotation axis of the gear.

12. The vent arrangement of claim 10, wherein:
the check valve is received by the further portion of the passage.

13. In a rotary machine having a housing enclosing a rotating part and enclosing a volume which can contain oil and pressurized air, the part having a first surface exposed to the volume and having a second surface exposed to the environment, a vent arrangement comprising:
a passage formed in the part, the passage having a first end communicating with the volume and having a second communicating with the environment, the passage having a portion thereof which extends radially through a portion of the part; and
a check valve which permits one-way flow of air through the passage from the volume to the environment.

14. The vent arrangement of claim 13, wherein:
the passage comprises a further portion which extends axially part way into the part and which has an outer end exposed to the environment.

15. The vent arrangement of claim 14, wherein:
the further portion of the passage is aligned with a rotation axis of the part.

16. The vent arrangement of claim 14, wherein:
the check valve is received by the further portion of the passage.
